(19) United States
(12) Patent Application Publication
(10) Pub. No.: US 2026/0008291 A1
(43) Pub. Date: Jan. 8, 2026

(54) POCKET CARD

(71) Applicant: HALLMARK CARDS, INCORPORATED, KANSAS CITY, MO (US)

(72) Inventors: LAURA LINEBARGER, PRAIRIE VILLAGE, KS (US); MARCOS MIGUEL ROMAN, KANSAS CITY, MO (US); ORLANDA DOMINIC LACY, KANSAS CITY, MO (US); ALISON T BAUER, KANSAS CITY, MO (US); MARY HUND EMANUEL, KANSAS CITY, MO (US)

(21) Appl. No.: 18/765,851

(22) Filed: Jul. 8, 2024

(51) Int. Cl. B42D 15/04

(52) U.S. Cl. CPC B42D 15/042

(57) ABSTRACT

A pocket card having a first sheet with a first peripheral edge and a second sheet with a second peripheral edge. The first and second sheets are coupled to each other at least at two spaced apart locations along respective lengths of the first and second peripheral edges to form a pocket positioned between the first and second sheets. The pocket is accessible from at least one opening positioned at a location where the first and second sheets are not coupled together. The first peripheral edge has a different shape than the second peripheral edge.

### BACKGROUND

When gifting a treat or other item to a person, a card is often presented with the gift as a thoughtful way to present a note to the receiver of the gift and to associate the gift with the person giving the gift. The card may include designs, decorative images, and/or text that relate to the reason why the gift is being given. For example, the card may include images or text that relate to a holiday, anniversary, or birthday. When gifting larger items, the gift may be wrapped in wrapping paper or presented in a gift bag along with a card. When gifting smaller items, the gift may be unwrapped and simply presented along with a small card, or the gift may even be taped to the card. School-aged children often take small gifts to their classmates for occasions such as birthdays, Halloween, or Valentine's Day. When delivering such gifts to their classmates, the gifts are often delivered with a note card. Taping numerous gifts to individual note cards can be a relatively time-consuming process. Further, many types of gifts or treats are not shaped in a manner that is conducive to taping. A taped gift or treat may also fall off of the note card during transport from home to school, and the gift or note card may become lost in the process. A gift delivered alongside a note card may also become lost during transport. It may also be difficult for the receiver of the gift to determine which gift is associated with which note card, particularly if the receiver receives many gifts at or near the same time from a variety of different individuals.

### SUMMARY

A pocket card in accordance with one aspect of the invention described herein includes a first sheet comprising a first peripheral edge and a second sheet comprising a second peripheral edge. The first and second sheets are coupled to each other at least at two spaced apart locations along respective lengths of the first and second peripheral edges to form a pocket positioned between the first and second sheets. The pocket is accessible from at least one opening positioned at a location where the first and second sheets are not coupled together. The first peripheral edge has a different shape than the second peripheral edge.

In some embodiments, the first peripheral edge may have first and second side edges and first and second end edges extending between the first and second side edges. The second peripheral edge may have third and fourth side edges and third and fourth end edges extending between the third and fourth side edges. The first and second sheets may be coupled to each other along at least a portion of respective lengths of the first and third side edges. The first and second sheets may be coupled to each other along at least a portion of respective lengths of the second and fourth side edges. The at least one opening may be positioned adjacent the first and third end edges.

In some embodiments, the first end edge may have a different shape than the third end edge such that at least a portion of the first end edge is offset from the third end edge in a direction extending toward the second end edge. The pocket may be accessible from a second opening adjacent the second and fourth end edges. A wafer seal may be configured to adhere to the first and second sheets to at least partially close the second opening. The first sheet may have a flap extending outward from the second end edge and/or the second sheet may have a flap extending outward from the fourth end edge. The flap being foldable to close the second opening.

In some embodiments, the first and second sheets may be coupled to each other with a first expandable closure adjacent the second and fourth end edges, a second expandable closure adjacent the first and third side edges, and a third expandable closure adjacent the second and fourth side edges. The first, second, and third expandable closures may allow the first and second sheets to move toward and away from each other to alter a volume of the pocket.

In some embodiments, the first sheet may be formed integral with the second sheet, with the first and third side edges defined by a fold positioned at the first and third side edges. The first sheet may have a tab extending outward from the second side edge that is joined to an inner surface of the second sheet adjacent the fourth side edge, or the second sheet may have a tab extending outward from the fourth side edge that is joined to an inner surface of the first sheet adjacent the second side edge.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a pocket card in accordance with an exemplary embodiment of the invention described herein showing one side of the pocket card;

FIG. 2 is a perspective view of the pocket card of FIG. 1 showing an opposite side of the pocket card;

FIG. 3 is a perspective view of the pocket card of FIG. 1 showing an item received within a pocket of the pocket card;

FIG. 4 is a plan view of the pocket card of FIG. 1 prior to assembly and with the decorative images shown in FIGS. 1-3 omitted;

FIG. 5 is a front view of an alternative embodiment of pocket card;

FIG. 6 is a plan view of the pocket card of FIG. 5 prior to assembly and with the decorative image shown in FIG. 5 omitted;

FIG. 7 is a perspective view of another alternative embodiment of pocket card showing one side of the pocket card;

FIG. 8 is a perspective view of the pocket card of FIG. 7 showing an opposite side of the pocket card;

FIG. 9 is a perspective view of the pocket card of FIG. 7 showing an item received within a pocket of the pocket card;

FIG. 10 is a plan view of the pocket card of FIG. 7 prior to assembly and with the decorative images shown in FIGS. 7-9 omitted;

FIG. 11 is a front view of an alternative embodiment of pocket card;

FIG. 12 is a plan view of the pocket card of FIG. 11 prior to assembly and with the decorative image shown in FIG. 11 omitted;

FIG. 13 is a perspective view of an alternative embodiment of pocket card having expandable closures;

FIG. 14 is another perspective view of the pocket card of FIG. 13;

FIG. 15 is a plan view of the pocket card of FIG. 13 prior to assembly;

FIG. 16 is a perspective view of another alternative embodiment of pocket card having flaps to close one end of the pocket card; and

FIG. 17 is a plan view of the pocket card of FIG. 16 prior to assembly.

### DETAILED DESCRIPTION OF EXEMPLARY EMBODIMENT

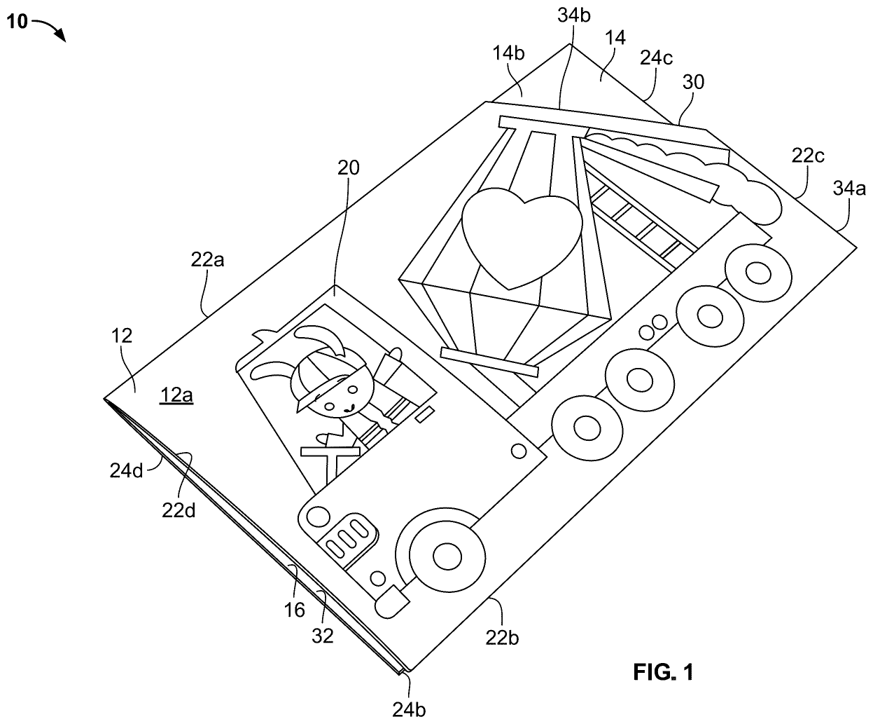

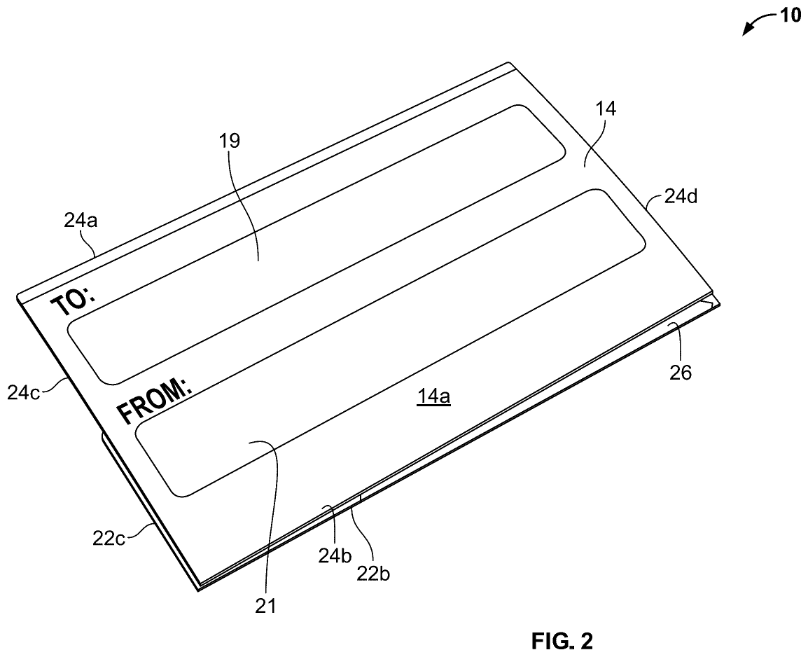

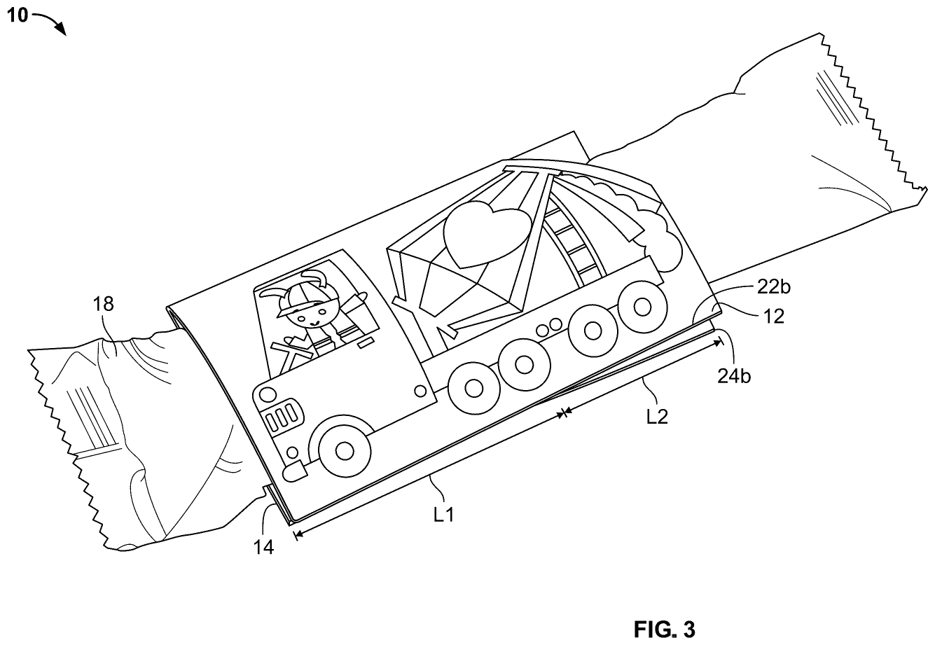

A pocket card in accordance with one exemplary embodiment of the invention described herein is identified generally as 10 in FIG. 1. The pocket card 10 includes a first sheet 12 and a second sheet 14 that are joined together as described below to define a pocket 16 positioned between the first and second sheets 12 and 14. As shown in FIG. 3, the pocket 16 may be configured to hold an item 18, such as a candy bar or other gift or treat. The pocket card 10 may further include a decorative image 20 on its first sheet 12, as shown in FIG. 1. As shown in FIG. 2, the pocket card 10 may also include space on its second sheet 14 to write a note. For example, the pocket card 10 includes a space 19 under the heading “TO:” to write the name of an intended recipient of the pocket card 10, and another space 21 under the heading “FROM:” to write the name of the person giving the pocket card 10. The “TO:” and “FROM:” headings and spaces 19 and 21 are optional may be omitted from the pocket card 10. Instead of, or in addition to, the “TO:” and “FROM:” headings and spaces 19 and 21, the pocket card 10 may have a decorative image, editorial message, and/or space in which a user may write a note. The pocket card 10 may be suitable for gifting treats or items to others in a thoughtful and decorative manner. The pocket card 10 may have any desired size. For example, the pocket card 10 may be sized similar to a note card, a gift or greeting card, or it may have any other suitable size or shape.

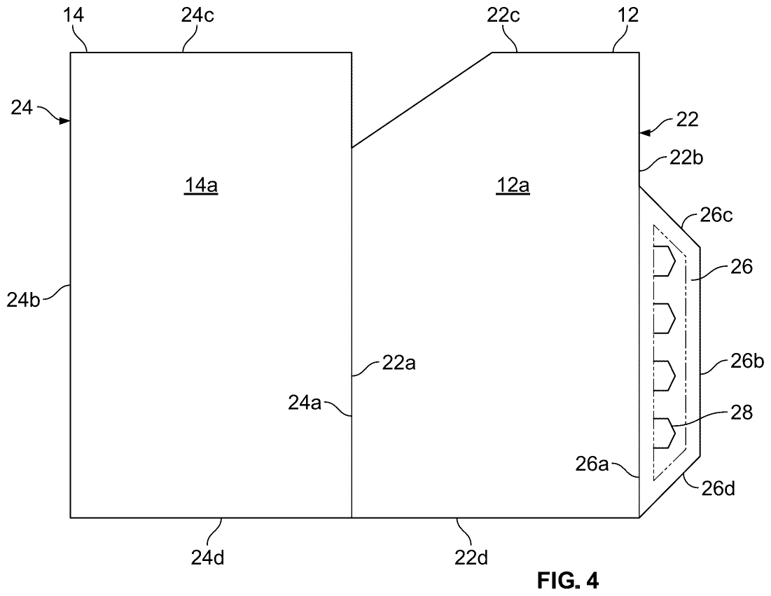

Referring to FIG. 4, the first sheet 12 has a first peripheral edge 22 and the second sheet 14 has a second peripheral edge 24. The first peripheral edge 22 includes first and second side edges 22a-b and first and second end edges 22c-d extending between the first and second side edges 22a-b. The second peripheral edge 24 includes third and fourth side edges 24a-b and third and fourth end edges 24c-d extending between the third and fourth side edges 24a-b. For the pocket card 10 shown in FIGS. 1-4, the first and second sheets 12 and 14 are formed integrally with each other from a single piece of material (e.g., cardstock) that may be diecut into the shape shown in FIG. 4. The first and second sheets 12 and 14 are delineated by a fold positioned at the first side edge 22a and the third side edge 24a. For example, the single piece of material forming the first and second sheets 12 and 14 is folded at the first and third side edges 22a and 24a to define the first and second sheets 12 and 14. FIG. 4 shows outer surfaces 12a and 14a of the first and second sheets 12 and 14, respectively. The outer surfaces 12a and 14a are shown in FIGS. 1 and 2, respectively, and are positioned on the exterior of the pocket card 10 when formed. The first and second sheets 12 and 14 are generally planar and have inner surfaces on the opposite side of the sheets from the outer surfaces 12a and 14a. For example, the inner surface 14b of second sheet 14 is shown in FIG. 1 at the corner of the pocket card 10 where the first sheet 12 does not cover the second sheet 14. The inner surfaces of the first and second sheets 12 and 14 face the pocket 16 when the pocket card 10 is formed into the configuration shown in FIGS. 1-3.

A tab 26 extends outward from the second side edge 22b of the first sheet 12. The tab 26 is trapezoidal in shape with a first side edge 26a that coextends with a portion of the second side edge 22b of the first sheet 12, a second side edge 26b parallel to the first side edge 26a, and first and second end edges 26c-d that extend from the first side edge 26a at an angle toward the second side edge 26b. The tab 26 is formed integrally with the first and second sheets 12 and 14 from a single sheet of material. The tab 26 is delineated from the first sheet 12 by a fold positioned at the second side edge 22b of the first sheet 12 and the first side edge 26a of the tab 26. Adhesive 28 is deposited on the tab 26, as shown in FIG. 4. The tab 26 extends from the second end edge 22d of the first sheet 12 toward the first end edge 22c a distance that is approximately two-thirds of the length of the second side edge 22b.

After the pocket card 10 is cut into the shape shown in FIG. 4, and adhesive 28 is applied to the tab 26, the pocket card 10 is assembled into the configuration shown in FIGS. 1-3 by folding the first sheet 12 toward the second sheet 14 along the fold line defined by the side edges 22a and 24a so that the outer surfaces 12a and 14a face outward after folded. The tab 26 is also folded toward the inner surface 14b of the second sheet 14. The tab 26 is pressed against the second sheet 14 so that the adhesive 28 on the tab 26 adheres to the inner surface 14b of the second sheet 14 adjacent the fourth side edge 24b. Adhering the tab 26 to the second sheet 14 couples the first and second sheets 12 and 14 together along a portion of the respective lengths of the second and fourth side edges 22b and 24b, as shown in FIG. 2. Since the first and second sheets 12 and 14 are integrally formed together, they are also coupled together along the respective lengths of the first and third side edges 22a and 24a. The first and second sheets 12 and 14 may have a cut score at the fold lines defined by the edges 22a, 24a and the edges 22b, 26a to facilitate folding the sheets along the fold lines.

Referring to FIG. 1, the pocket card 10 includes a first opening 30 and a second opening 32 that are defined by the first and second sheets 12 and 14. The pocket 16 is accessible through the first opening 30 and the second opening 32. The first opening 30 is positioned adjacent the first and third end edges 22c and 24c, and the second opening 32 is positioned adjacent the second and fourth end edges 22d and 24d. The item 18 (FIG. 3) may be inserted into the pocket 16 through either of the first or second openings 30 or 32.

The first end edge 22c of the first sheet 12 has a different shape than the third end edge 24c of the second sheet 14. As shown in FIG. 1, the first end edge 22c includes a first section 34a that extends from the second side edge 22b toward the first side edge 22a. The first section 34a is generally aligned with the third end edge 24c of the second sheet 14. A second section 34b of the first end edge 22c extends from the first section 34a at an angle toward the first side edge 22a. The configuration of the second section 34b exposes a portion of the inner surface 14b of the second sheet 14. The first side edge 22a also has a different shape than the third side edge 24a. In this manner, a portion of the first end edge 22c is offset from the third end edge 24c in a direction extending toward the second end edge 22d, and the first peripheral edge 22 is at least partially offset from the second peripheral edge 24 inward toward the middle of the pocket card 10. The offset creates an area where an item, e.g., the item 18 shown in FIG. 3, inserted in the pocket 16 may be supported by the second sheet 14, while not being covered by the first sheet 12. This may allow the item to be seen by someone receiving the pocket card 10 even if the remainder of the item is hidden within the pocket 16. As shown in FIG. 1, the second section 34b creating the offset is cut to generally align with a portion of the decorative image 20 on the first sheet 12. For example, the second section 34b is cut to be generally parallel with a rear of the mixer drum portion of the decorative image 20.

The pocket card 10 may be configured so that the pocket 16 is capable of receiving items of a variety of different sizes. For example, referring to FIG. 3, the length along the second and fourth side edges 22b and 24b where the tab 26 couples those edges is identified as L1, and the length along the second and fourth side edges 22b and 24b where the side edges are not coupled together is identified as L2. Along the length L2, the first and second sheets 12 and 14 may separate from each other when an item 18 is inserted in the pocket 16. FIG. 3 shows the first and second sheets 12 and 14 separated away from each other due to the item 18 forcing the sheets away from each other along the length L2. The uncoupled length L2 of the side edges 22b and 24b may allow larger items to be placed in the pocket 16.

The pocket card 10 may also be configured for retaining items placed within the pocket 16. For example, when an item is inserted in the pocket, such as the item 18 shown in FIG. 3, the first and second sheets 12 and 14 may be slightly bent or curved away from each other to increase the volume of the pocket 16 and allow it to receive the item 18. When a force is exerted on the first and second sheets 12 and 14 to curve them so that the item 18 may be placed in the pocket 16, the item 18 may exert a force on the first and second sheets 12 and 14 biasing them away from each other and their natural generally planar configuration. The first and second sheets 12 and 14 may exert a reaction force on the item 18, which may impede or prevent the item 18 from falling out of the pocket 16. Friction between the item 18 and the first and/or second sheets 12 and 14 may also impede or prevent the item 18 from falling out of the pocket 16.

Other than the offset of the first sheet 12 at the first end edge 22c as described above, the first and second sheets 12 and 14 of the pocket card 10 are generally rectangular. The first and second sheets 12 and 14, however, may be formed to have any other suitable shape that allows a pocket to be formed between the sheets when the peripheral edges of the sheets are coupled to each other at least at two spaced apart locations along their respective lengths. For example, the sheets may be generally circular, oval-shaped, triangular, square, or any other polygonal or irregular shape. Further, although the pocket card 10 shown in FIGS. 1-4 has first and second sheets 12 and 14 each having two side edges and two end edges, the first and second sheets 12 and 14 may each have a peripheral edge that includes one continuous edge (e.g., the sheets may have a circular, generally circular, oval or other ellipsoidal shape), three side edges (e.g., the sheets may have a generally triangular shape), or the sheets may have any other suitable number of side or end edges. The first and second sheets may also be different shapes than each other, including any of the shapes noted above. In each case, the peripheral edge of one of the sheets has a different shape than the peripheral edge of the other of the sheets to form an offset similar to as described above with respect to pocket card 10.

Further, while the first and second sheets 12 and 14 are formed from a single piece of material that is folded to delineate between the first and second sheets 12 and 14, the first and second sheets 12 and 14 may be formed from separate pieces of material that are coupled to each other at least at two spaced apart locations along their respective lengths. For example, referring to FIG. 4, the first and second sheets 12 and 14 may be separated from each other along the fold line shown as the edges 22a and 24a. The first sheet 12 may have a second tab, like the tab 26, extending outward from the first side edge 22a. The second tab may have adhesive on it and be folded back toward the inner surface of the first sheet 12 like the tab 26. The adhesive on the two tabs may then be pressed against the inner surface 14b of the second sheet 14 to join the two sheets together in a substantially similar configuration as that shown in FIGS. 1-3. Further, instead of the first sheet 12 having two tabs, one or both of the tabs may extend outward from the second sheet 14 and have adhesive to join the second sheet 14 to the inner surface of the first sheet 12. For example, one of the tabs may extend outward from the third side edge 24a of the second sheet 14 and be joined to an inner surface of the first sheet adjacent the first side edge 22a. The pocket card 10 may also have the configuration shown in FIG. 4, but with the tab 26 extending outward from the fourth side edge 24b such that it can be adhered to an inner surface of the first sheet 12 adjacent the second side edge 22b. The first and second sheets 12 and 14 may further be coupled to each other at least at two spaced apart locations along their respective lengths by any suitable means, including being integrally formed together with a fold line between the sheets, adhesive, mechanical fasteners, e.g., staples, or any other suitable fastening structures or methods.

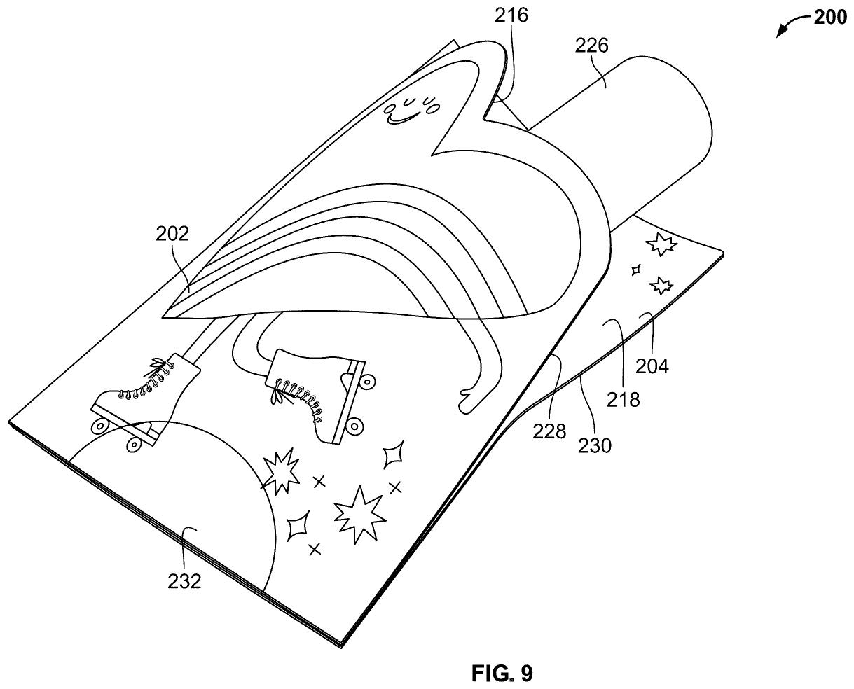

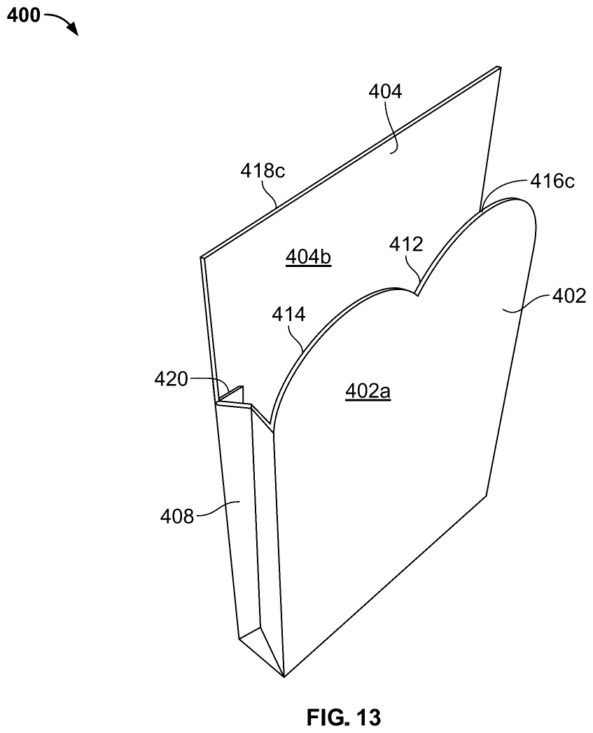

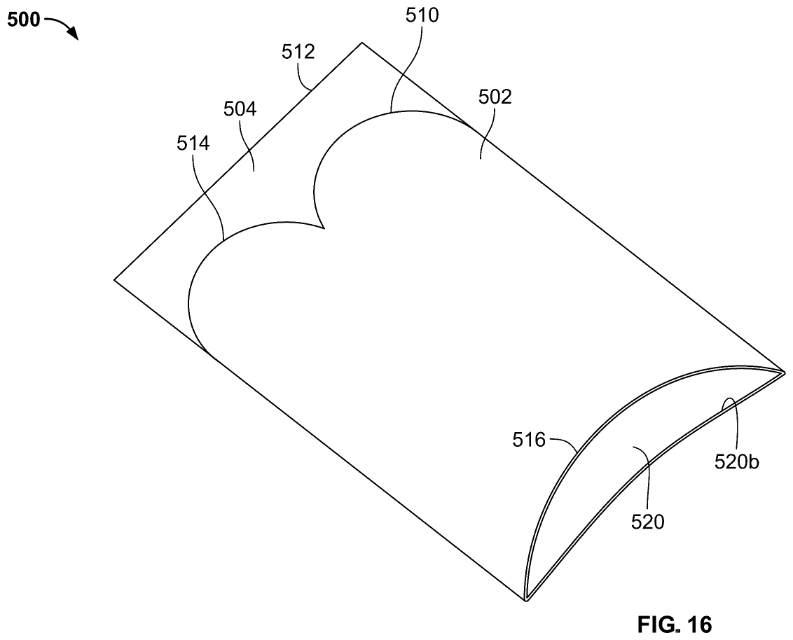

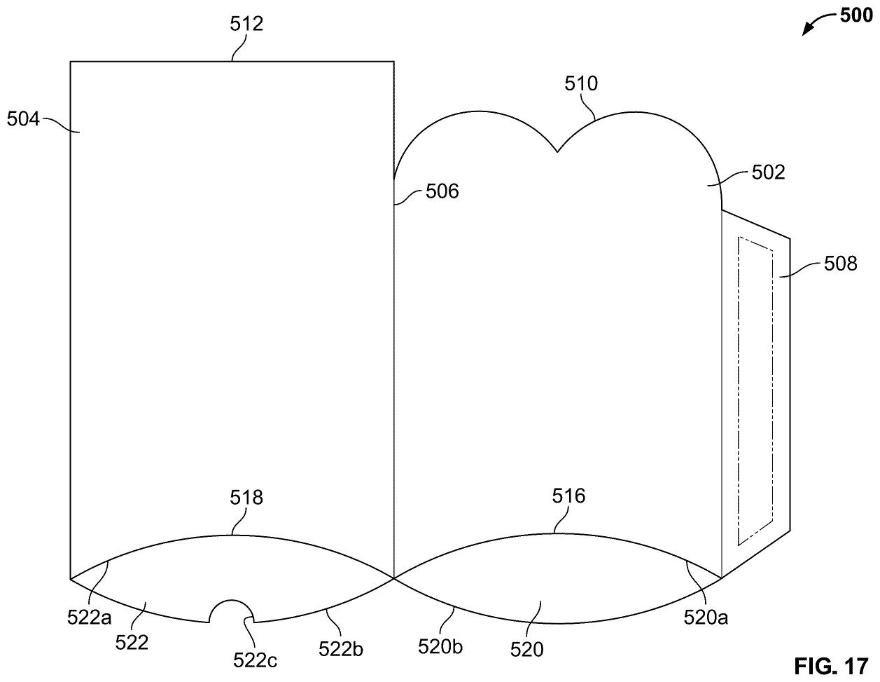

While the pocket 16 of the pocket card 10 is shown as being accessible from the first and second openings 30 and 32, the pocket 16 may be accessible from only one of the first and second openings 30 and 32 with the other of the openings being closed. For example, one of the openings 30 or 32 may be closed with a wafer seal, as described in more detail below with respect to FIG. 9, an expandable closure, as described in more detail below with respect to FIGS. 13-15, or flaps, as described in more detail below with respect to FIGS. 16-17. One of the openings 30 or 32 may further be closed with a tab, similar to tab 26. For example, a tab may extend outward from one of the end edges 22d or 24d. The tab may include adhesive and be folded back, similar to tab 26, so that it can adhere to the inner surface of the sheet from which it does not extend. The pocket card 10 thus may have only one opening, or it may have two openings, with a structure such as a wafer seal or a flap provided for a user to selectably close one of the openings. The pocket card 10 further may have more than two openings. For example, if the peripheral edges of the first and second sheets 12 and 14 are coupled together at more than two locations, the pocket 16 may be accessible through more than two openings with each of the openings positioned between adjacent locations where the sheets are coupled together.

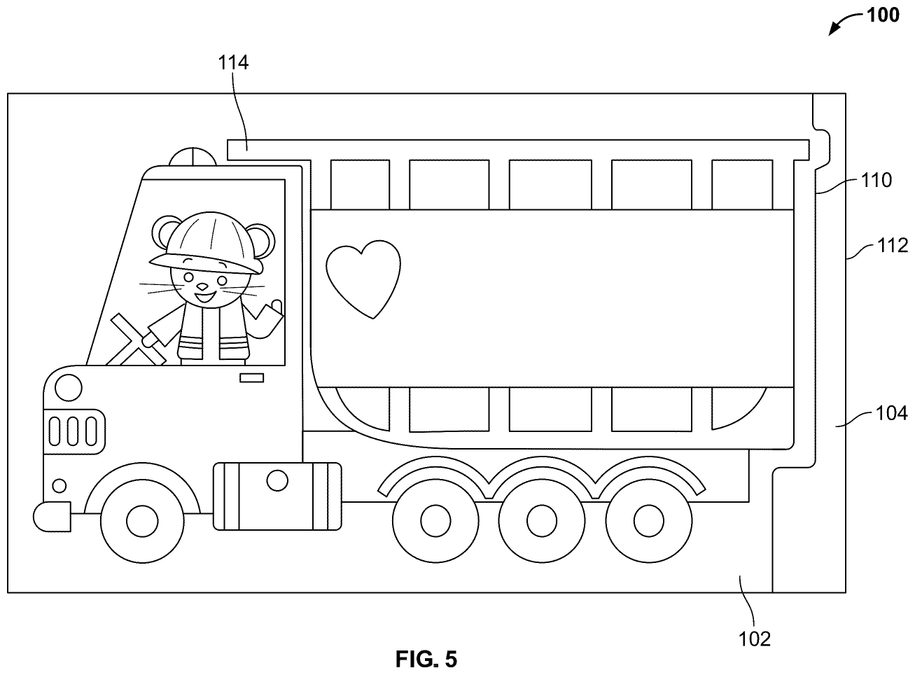

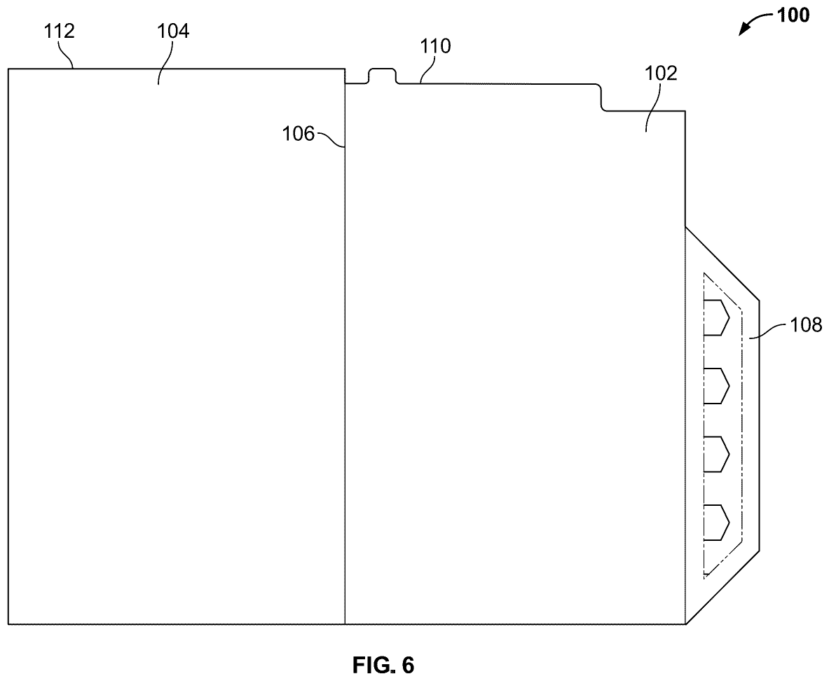

FIGS. 5 and 6 show an alternative embodiment of pocket card 100 that is substantially similar to the pocket card 10. Accordingly, only the differences between pocket cards 10 and 100 are described in detail herein. The pocket card 100 has a first sheet 102 and a second sheet 104. The sheets 102 and 104 are formed from a single piece of material, as shown in FIG. 6, with a fold line 106 positioned at side edges of the sheets 102 and 104 defining the boundary between the sheets. A tab 108 with adhesive extends outward from the sheet 102 to join the sheet 102 to the sheet 104 in a similar manner as described above with respect to pocket card 10. The sheet 102 has an end edge 110 with a different shape than an end edge 112 of the sheet 104. The shape of the end edge 110 generally matches the shape of the rear of a decorative image 114 on the first sheet 102. The difference in shape creates an offset in that the end edge 110 of the first sheet 102 is offset from the end edge 112 of the second sheet 104 in a direction extending toward the opposite end of the pocket card 100. The pocket card 100 has at least a first opening at the end edges 110 and 112 through which a pocket between the sheets 102 and 104 is accessible. The offset may allow at least a portion of an item inserted in the pocket between the sheets 102 and 104 to be visible in a similar manner as described above with respect to pocket card 10.

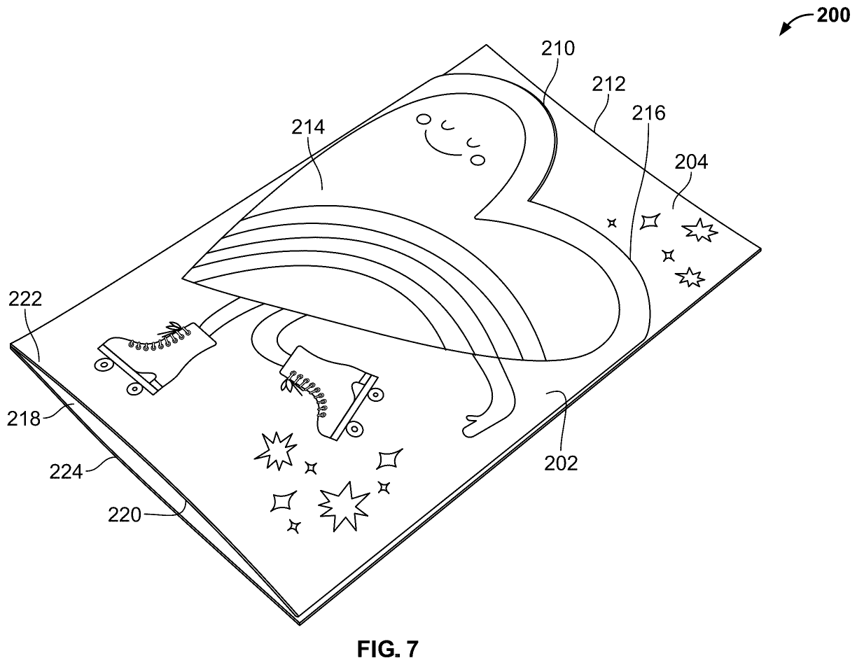

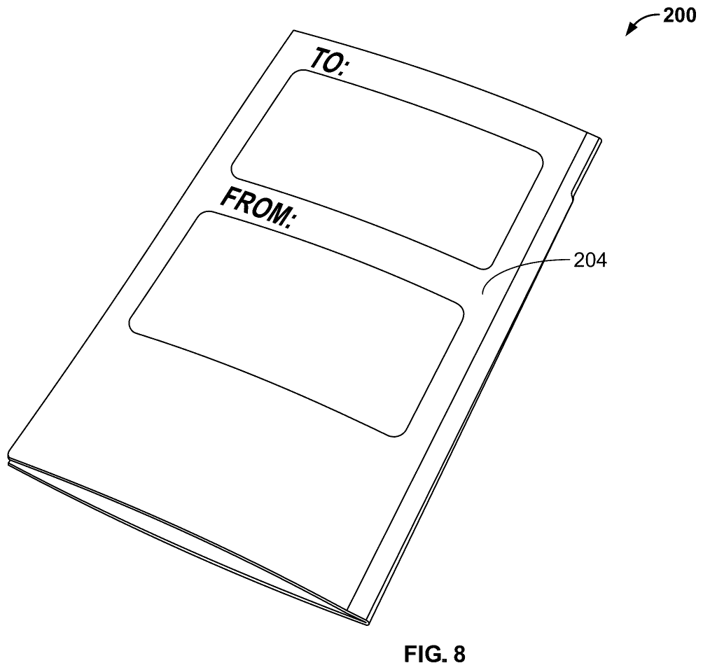

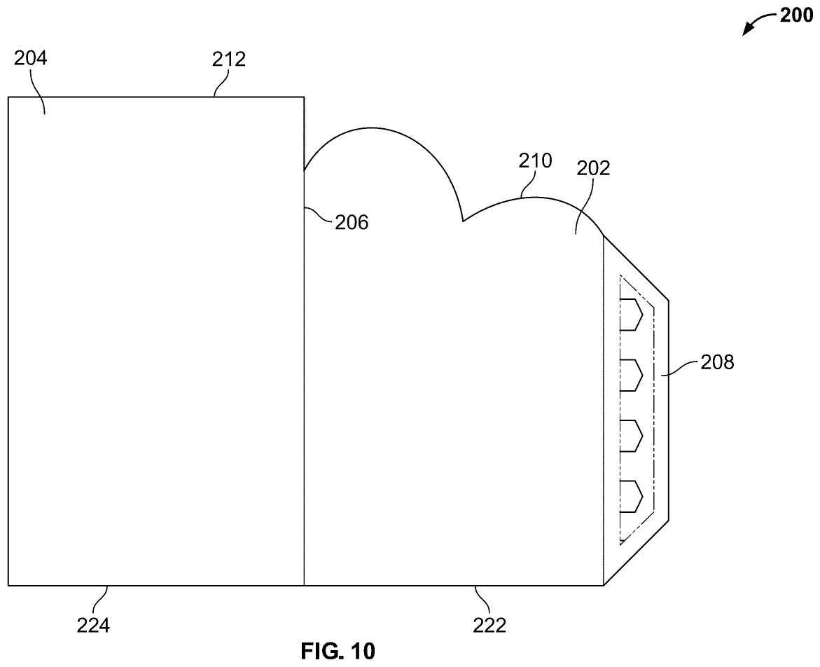

FIGS. 7-10 show another alternative embodiment of pocket card 200. Pocket card 200 is also substantially similar to pocket card 10. Accordingly, only the differences between the cards 10 and 200 are described in detail herein. The pocket card 200 has a first sheet 202 and a second sheet 204. The sheets 202 and 204 are formed from a single piece of material, as shown in FIG. 10, with a fold line 206 positioned at side edges of the sheets 202 and 204 defining the boundary between the sheets. A tab 208 with adhesive extends outward from the sheet 202 to join the sheet 202 to the sheet 204 in a similar manner as described above with respect to pocket card 10. The sheet 202 has an end edge 210 with a different shape than an end edge 212 of the sheet 204. The shape of the end edge 210 generally matches the shape of the top of a decorative image 214 on the first sheet 202. The decorative image 214 of the pocket card 200 is oriented vertically, or in a portrait orientation, whereas the decorative images of the pocket cards 10 and 100 are oriented horizontally, or in a landscape orientation. The difference in shape between the end edges 210 and 212 creates an offset in that the end edge 210 of the first sheet 202 is offset from the end edge 212 of the second sheet 204 in a direction extending toward the opposite end of the pocket card 200. The pocket card 200 has a first opening 216 at the end edges 210 and 212 through which a pocket 218 between the sheets 202 and 204 is accessible, and a second opening 220 at opposite end edges 222 and 224. As with the pocket cards 10 and 100 described above and as shown in FIG. 9, the offset may allow at least a portion of an item 226 inserted in the pocket 218 to be visible. As shown in FIG. 9, the item 226 is relatively thick, which causes the sheets 202 and 204 to separate from each other along the portion of side edges 228 and 230 where the sheets 202 and 204 are not coupled together with the tab 208 (FIG. 10).

The pocket card 200 includes a wafer seal 232, shown in FIG. 9, that may be used to close the second opening 220. The wafer seal 232 is generally circular and has adhesive on one side that may adhere to outer surfaces of the first and second sheets 202 and 204 adjacent the second opening 220. The wafer seal 232 may be generally clear or transparent so that the decorative image may still be seen through the wafer seal 232 when it is used. The wafer seal 232 may be used when, for example, smaller items are placed within the pocket 218. The wafer seal 232 may impede or prevent smaller items from falling out of the pocket 218 through the second opening 220 when the card is in a vertical orientation with the first opening 216 positioned above the second opening 220. When the pocket 218 retains smaller items that do not protrude through the first opening 216, another wafer seal may be used to close the first opening 216.

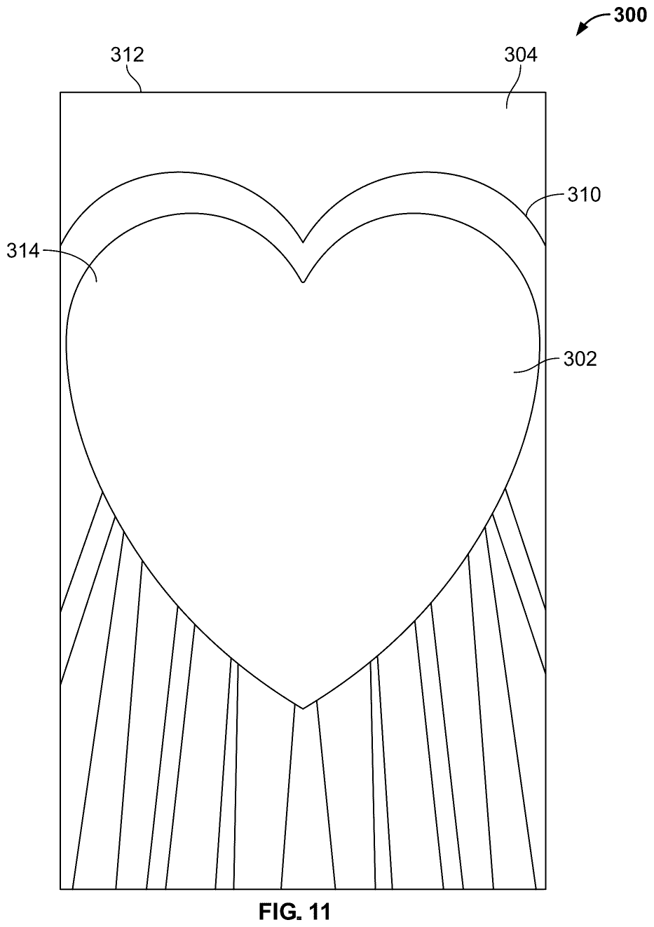

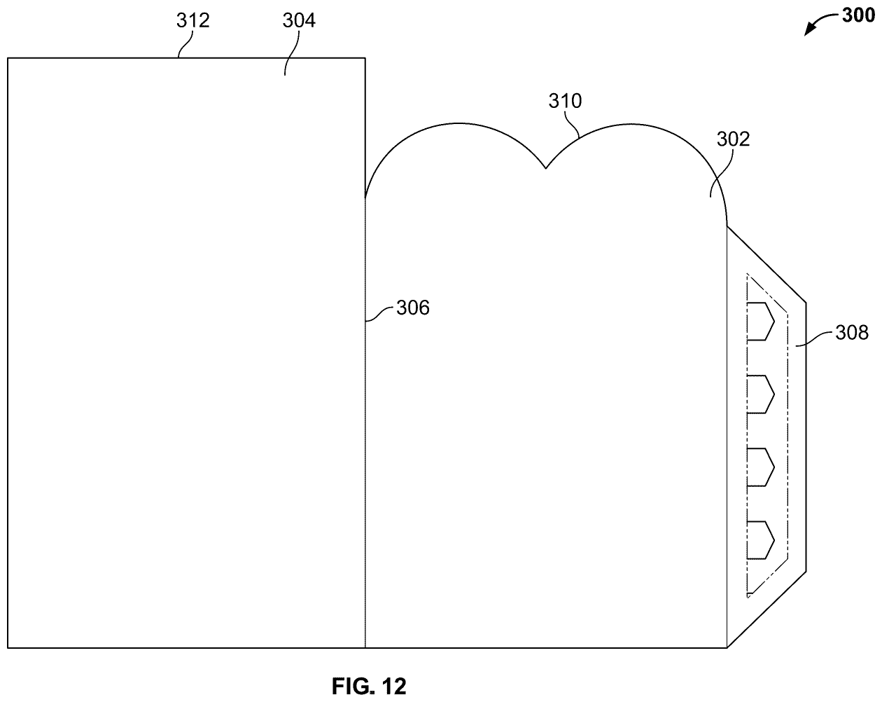

Referring to FIGS. 11 and 12, another alternative embodiment of pocket card is generally identified with the reference numeral 300. Pocket card 300 is also substantially similar to the pocket card 10. Accordingly, only the differences between pocket cards 10 and 300 are described in detail herein. The pocket card 300 has a first sheet 302 and a second sheet 304. The sheets 302 and 304 are formed from a single piece of material, as shown in FIG. 12, with a fold line 306 positioned at side edges of the sheets 302 and 304 defining the boundary between the sheets. A tab 308 with adhesive extends outward from the sheet 302 to join the sheet 302 to the sheet 304 in a similar manner as described above with respect to pocket card 10. The sheet 302 has an end edge 310 with a different shape than an end edge 312 of the sheet 304. The shape of the end edge 310 generally matches the shape of the top of a decorative image 314 on the first sheet 302. The difference in shape creates an offset in that the end edge 310 of the first sheet 302 is offset from the end edge 312 of the second sheet 304 in a direction extending toward the opposite end of the pocket card 300. The pocket card 300 has at least a first opening at the end edges 310 and 312 through which a pocket between the sheets 302 and 304 is accessible. The offset may allow at least a portion of an item inserted in the pocket between the sheets 302 and 304 to be visible in a similar manner as described above with respect to pocket card 10.

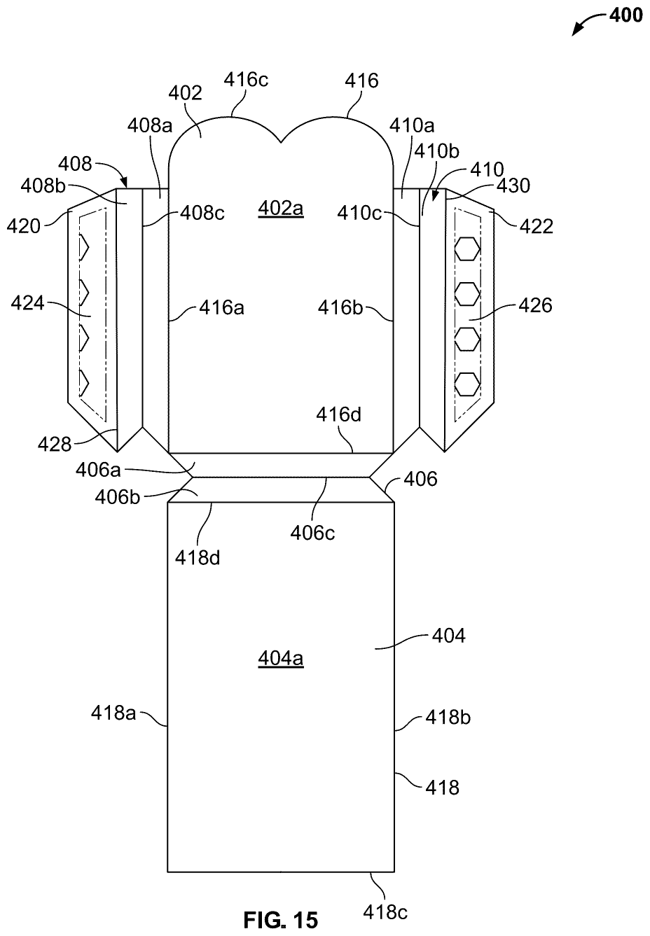

Another alternative embodiment of pocket card 400 is shown in FIGS. 13-15. The pocket card 400 has similar functionality as the pocket card 10 described above, but has expandable closures on its sides and one end as described in more detail below. The pocket card 400 includes a first sheet 402 and a second sheet 404 that are coupled together with first, second, and third expandable closures 406, 408, and 410 (FIG. 15). A pocket 412 positioned between the first and second sheets 402 and 404 is accessible through an opening 414.

Referring to FIG. 15, the first sheet 402 has a first peripheral edge 416 and the second sheet 404 has a second peripheral edge 418. The first peripheral edge 416 includes first and second side edges 416a-b and first and second end edges 416c-d extending between the first and second side edges 416a-b. The second peripheral edge 418 includes third and fourth side edges 418a-b and third and fourth end edges 418c-d extending between the third and fourth side edges 418a-b. The first expandable closure 406 extends outward from each of the second end edge 416d and the fourth end edge 418d to couple the second end edge 416d to the fourth end edge 418d. The second expandable closure 408 extends outward from the first side edge 416a of the first sheet 402, and the third expandable closure 410 extends outward from the second side edge 416b of the first sheet 402. A first tab 420 extends outward from the second expandable closure 408, and a second tab 422 extends outward from the third expandable closure 410. Adhesive 424 and 426 is deposited on the first and second tabs 420 and 422, respectively. The first and second sheets 402 and 404, first, second, and third expandable closures 406, 408, and 410, and first and second tabs 420 and 422 are all formed integrally with each other from a single piece of material that may be diecut into the shape shown in FIG. 15. FIG. 15 shows outer surfaces 402a and 404a of the first and second sheets 402 and 404, respectively.

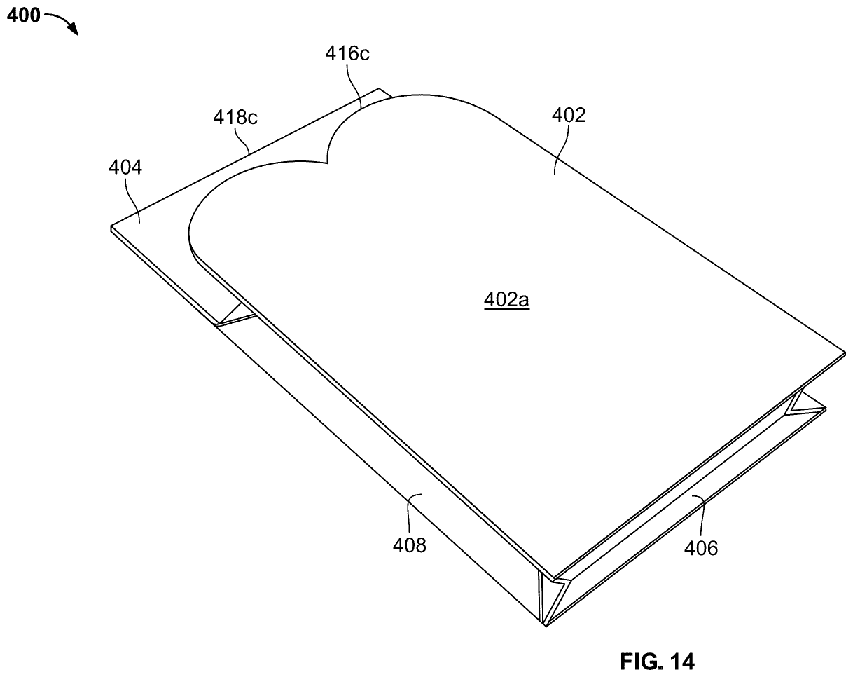

To assemble the pocket card 400, the first, second, and third expandable closures 406, 408, and 410 are folded away from the outer surface 402a of the first sheet 402 along fold lines defined by the end edge 416d and the side edges 416a-b. For example, FIG. 13 shows the second expandable closure 408 folded to extend away from the outer surface 402a at an angle, and FIG. 14 shows the first expandable closure 406 folded to extend away from the outer surface 402a at an angle. The second sheet 404 is folded along a fold line defined by the edge 418d from the position shown in FIG. 15 to the position shown in FIG. 13 so that the inner surface 404b of the second sheet 404 faces the first sheet 402. The tabs 420 and 422 are also folded along fold lines 428 and 430, respectively, until the adhesive 424 and 426 faces away from the first sheet 402. The tabs 420 and 422 are pressed against the inner surface 404b of the second sheet 404 so that the adhesive 424 and 426 joins the tabs 420 and 422 to the second sheet 404. For example, FIG. 13 shows the tab 420 adhered to the second sheet 404. The first tab 420 is adhered to the second sheet 404 adjacent the third side edge 418a, and the second tab 422 is adhered to the second sheet 404 adjacent the fourth side edge 418b. When assembled, the first and second sheets 402 and 404 are coupled to each other with the first expandable closure 406 extending between the second end edge 416d and the fourth end edge 418d, the second expandable closure 408 extending between the first side edge 416a and the third side edge 418a, and the third expandable closure 410 extending between the second side edge 416b and the fourth side edge 418b.

Each of the first, second, and third expandable closures 406, 408, and 410 includes first and second sections with a fold line positioned between the sections. For example, the first expandable closure 406 includes first and second sections 406a-b with a fold line 406c. The first section 406a extends from the first sheet 402 and the second section 406b extends from the second sheet 404. The fold line 406c is generally parallel to the end edges 416d and 418d of the first and second sheets 402 and 404. The second expandable closure 408 includes first and second sections 408a-b with a fold line 408c that is generally parallel to the side edge 416a, and the third expandable closure 410 includes first and second sections 410a-b with a fold line 410c that is generally parallel to the side edge 416b. The first, second, and third expandable closures 406, 408, 410 allow the first and second sheets 402, 404 to move toward and away from each other to alter a volume of the pocket 412 (FIG. 13). For example, if the first and second sheets 402 and 404 are pressed toward each other, the first and second sections of each of the expandable closures 406, 408, and 410 may move toward each other by folding along the fold lines 406c, 408c, and 410c to decrease a volume of the pocket 412. If the first and second sheets 402 and 404 are pulled away from each other, the first and second sections of each of the expandable closures 406, 408, and 410 may move away from each other to increase a volume of the pocket 412. Any of the fold lines of the pocket card 400 may be formed with a crease score or a cut score.

The peripheral edge 416 of the first sheet 402 has an end edge 416c with a different shape than the end edge 418c of the second sheet 404. As shown in FIGS. 13 and 14, the difference in shape creates an offset in that the end edge 416c of the first sheet 402 is offset from the end edge 418c of the second sheet 404 in a direction extending toward the opposite end of the pocket card 400. The offset may allow at least a portion of an item inserted in the pocket 412 between the sheets 402 and 404 to be visible in a similar manner as described above with respect to pocket card 10.

Another alternative embodiment of pocket card 500 is shown in FIGS. 16 and 17. The pocket card 500 is structured and operates similar to the pocket card 10 described above. Accordingly, only the differences between the pocket cards 10 and 500 are described in detail herein. The pocket card 500 includes first and second sheets 502 and 504. The sheets 502 and 504 are formed from a single piece of material, as shown in FIG. 17, with a fold line 506 positioned at side edges of the sheets 502 and 504 defining the boundary between the sheets. A tab 508 with adhesive extends outward from the sheet 502 to join the sheet 502 to the sheet 504 in a similar manner as described above with respect to pocket card 10. The sheet 502 has an end edge 510 with a different shape than an end edge 512 of the sheet 504. The difference in shape creates an offset in that the end edge 510 of the first sheet 502 is offset from the end edge 512 of the second sheet 504 in a direction extending toward the opposite end of the pocket card 500. The pocket card 500 has a first opening 514 at the end edges 510 and 512 through which a pocket between the sheets 502 and 504 is accessible. The offset may allow at least a portion of an item inserted in the pocket between the sheets 502 and 504 to be visible in a similar manner as described above with respect to pocket card 10.

The first and second sheets 502 and 504 have end edges 516 and 518 opposite end edges 510 and 512, respectively. The end edges 516 and 518 are curved such that they are concave with a curve extending toward the opposite end edges 510 and 512, respectively. Flaps 520 and 522 extend outward from the curved end edges 516 and 518, respectively. The flaps 520 and 522 are shaped similar to a vesica piscis, or ellipse with pointed ends. The flap 520 has convex curved sides 520a and 520b that meet at pointed ends. The curved side 520a is adjacent and has the same shape as the end edge 516 of the first sheet 502. The flap 522 has a similar shape as the flap 520 with curved sides 522a-b. The curved side 522b has a notch 522c that may be used to facilitate grasping and bending the flap 522 with respect to the second sheet 504. The flap 520 is foldable along a fold line defined by the end edge 516 and the side 520a, and the flap 522 is foldable along a fold line defined by the end edge 518 and the side 522a. A cut score may define the fold lines of the flaps 520 and 522.

As described above, the pocket of the pocket card 500 is accessible from a first opening 514 adjacent the end edges 510 and 512. The pocket is also accessible from a second opening adjacent the end edges 516 and 518 when the flaps 520 and 522 are in an open position, in which they are positioned generally parallel to the first and second sheets 502, 504 as shown in FIG. 17. The flaps 520 and 522 are movable from the open position to a closed position, as shown in FIG. 16. In the closed position, the flap 520 is folded to be generally perpendicular to the first sheet 502 such that the side 520b of the flap 520 is adjacent the end edge 518 (FIG. 17) of the second sheet 504. Likewise, when the flap 522 is in its closed position, the flap 522 is folded to be generally perpendicular to the second sheet 504 such that the side 522b of the flap 522 is positioned adjacent the end edge 516 of the first sheet 502. In the closed position, the flaps 520 and 522 close the second opening adjacent the end edges 516 and 518. FIG. 16 shows both of the flaps 520 and 522 closed with the flap 520 overlying the flap 522.

In use, each of the pocket cards 10, 100, 200, 300, 400, and 500 may be used to deliver a gift by placing the gift within the pocket of the pocket card. As described above, the offset at the end edges of each pocket card may allow a portion of the gift placed in the pocket to be visible to the recipient of the pocket card. The wafer seal 232 (FIG. 9), expandable closure 406 (FIG. 14), flaps 520 and 522 (FIG. 17), or other types of closures may be used to close at least one opening of the pocket card in order to impede or prevent the gift from falling out of the pocket.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A pocket card comprising:
a first sheet comprising a first peripheral edge; and
a second sheet comprising a second peripheral edge, the first and second sheets coupled to each other at least at two spaced apart locations along respective lengths of the first and second peripheral edges to form a pocket positioned between the first and second sheets, wherein the pocket is accessible from at least one opening positioned at a location where the first and second sheets are not coupled together, and
wherein the first peripheral edge has a different shape than the second peripheral edge.

2. The pocket card of claim 1, wherein the first peripheral edge comprises first and second side edges and first and second end edges extending between the first and second side edges, and the second peripheral edge comprises third and fourth side edges and third and fourth end edges extending between the third and fourth side edges, wherein the first and second sheets are coupled to each other along at least a portion of respective lengths of the first and third side edges, and the first and second sheets are coupled to each other along at least a portion of respective lengths of the second and fourth side edges, and wherein the at least one opening is positioned adjacent the first and third end edges.

3. The pocket card of claim 2, wherein the first end edge has a different shape than the third end edge such that at least a portion of the first end edge is offset from the third end edge in a direction extending toward the second end edge.

4. The pocket card of claim 3, wherein the pocket is accessible from a second opening adjacent the second and fourth end edges, and further comprising a wafer seal configured to adhere to the first and second sheets to at least partially close the second opening.

5. The pocket card of claim 3, wherein the pocket is accessible from a second opening adjacent the second and fourth end edges, and wherein the first sheet comprises a flap extending outward from the second end edge or the second sheet comprises a flap extending outward from the fourth end edge, the flap foldable to close the second opening.

6. The pocket card of claim 3, wherein the first and second sheets are coupled to each other along at least a portion of respective lengths of the second and fourth end edges.

7. The pocket card of claim 6, wherein the first and second sheets are coupled to each other with a first expandable closure adjacent the second and fourth end edges, a second expandable closure adjacent the first and third side edges, and a third expandable closure adjacent the second and fourth side edges, wherein the first, second, and third expandable closures allow the first and second sheets to move toward and away from each other to alter a volume of the pocket.

8. The pocket card of claim 2, wherein the first sheet is formed integral with the second sheet, and the first and third side edges are defined by a fold positioned at the first and third side edges.

9. The pocket card of claim 8, wherein either the first sheet comprises a tab extending outward from the second side edge that is joined to an inner surface of the second sheet adjacent the fourth side edge, or the second sheet comprises a tab extending outward from the fourth side edge that is joined to an inner surface of the first sheet adjacent the second side edge.

10. The pocket card of claim 1, wherein the pocket is accessible from a second opening, and further comprising a wafer seal configured to adhere to outer surfaces of the first and second sheets to at least partially close the second opening.

11. The pocket card of claim 1, wherein the pocket is accessible from a second opening, and wherein the first sheet comprises a flap extending outward from the first peripheral edge, the flap foldable toward the second sheet to close the second opening.

12. The pocket card of claim 1, wherein the first peripheral edge is offset from the second peripheral edge adjacent the at least one opening.

13. The pocket card of claim 1, wherein one of the first sheet or the second sheet is rectangular or square.

14. A pocket card comprising:
a first sheet comprising first and second side edges and first and second end edges extending between the first and second side edges; and
a second sheet comprising third and fourth side edges and third and fourth end edges extending between the third and fourth side edges, wherein the first and second sheets are coupled to each other along at least a portion of respective lengths of the first and third side edges, and the first and second sheets are coupled to each other along at least a portion of respective lengths of the second and fourth side edges to form a pocket positioned between the first and second sheets, and wherein the pocket is accessible from at least one opening positioned adjacent the first and third end edges, and
wherein the first end edge has a different shape than the third end edge such that at least a portion of the first end edge is offset from the third end edge in a direction extending toward the second end edge.

15. The pocket card of claim 14, wherein the pocket is accessible from a second opening adjacent the second and fourth end edges, and further comprising a wafer seal configured to adhere to the first and second sheets to at least partially close the second opening.

16. The pocket card of claim 14, wherein the pocket is accessible from a second opening adjacent the second and fourth end edges, and wherein the first sheet comprises a flap extending outward from the second end edge or the second sheet comprises a flap extending outward from the fourth end edge, the flap foldable to close the second opening.

17. The pocket card of claim 14, wherein the first and second sheets are coupled to each other along at least a portion of respective lengths of the second and fourth end edges.

18. The pocket card of claim 17, wherein the first and second sheets are coupled to each other with a first expandable closure adjacent the second and fourth end edges, a second expandable closure adjacent the first and third side edges, and a third expandable closure adjacent the second and fourth side edges, wherein the first, second, and third expandable closures allow the first and second sheets to move toward and away from each other to alter a volume of the pocket.

19. The pocket card of claim 14, wherein the first sheet is formed integral with the second sheet, and the first and third side edges are defined by a fold positioned at the first and third side edges.

20. The pocket card of claim 19, wherein either the first sheet comprises a tab extending outward from the second side edge that is joined to an inner surface of the second sheet adjacent the fourth side edge, or the second sheet comprises a tab extending outward from the fourth side edge that is joined to an inner surface of the first sheet adjacent the second side edge.
